(19) United States
(12) Patent Application Publication
(10) Pub. No.: US 2015/0068463 A1
(43) Pub. Date: Mar. 12, 2015

(54) PET TREAT DISPENSER SYSTEM

(71) Applicant: Jason Worry, Palo Alto, CA (US)

(72) Inventor: Jason Worry, Palo Alto, CA (US)

(21) Appl. No.: 14/020,842

(22) Filed: Sep. 8, 2013

(51) Int. Cl. A01K 5/00; A01K 29/00

(52) U.S. Cl. CPC A01K 5/00; A01K 29/00
USPC 119/57.1; 29/825

(57) ABSTRACT

A method of manufacturing a dispenser system includes: providing a housing including a front side; coupling a mechanism to the front side of the housing, the mechanism including a drive system and a storage unit; and connecting a circuit to the mechanism configured to dispense a consumable product contained in the storage unit after a remote command is received by the circuit.

### FIELD OF THE INVENTION

The field of the invention is related to snack or treat dispenser product, in particular to a pet treat dispenser for use in the pet care industry but applicable to other industries where a snack/treat dispenser would be useful.

### BACKGROUND OF THE INVENTION

Around the world pets fulfill a vital importance in the lives of many pet owners. Caring for pets has become an increasingly refined and necessary part of pet ownership. Today more than ever, pet owners are leaving their pets at home without constant supervision while the owners travel or work.

A solution to provide pet owners with the ability to remotely care for the needs of their pets with the moment by moment discretion of a caring pet owner has eluded those skilled in the art. Many attempts to solve these problems have been made but none have yet been able to provide a full and complete solution.

One solution that has been developed is a dispenser with a timer that dispenses food at a certain time. This solution fails to provide for the individualized needs of a pet during different times of the day. For instance after a good exercise in the yard a pet may need two treats, but this system would only provide a standard predetermined quantity at predetermined intervals rather than when it is really needed.

Other solutions will refill a bowl as it drains. These solutions can over feed a pet leading to poor pet health.

Currently, there is not a pet treating dispenser of the present invention that can be remotely controlled/operated that solves the problem of allowing a pet owner to remotely provide a treat to his/her pet. Thus the need to allow pet owners to remotely take care of their pets has been long felt in the industry and has long eluded those skilled in the art.

### SUMMARY OF THE INVENTION

The present invention provides a method of manufacturing a dispenser system including: providing a housing including a front side; coupling a mechanism to the front side of the housing, the mechanism including a drive system and a storage unit; and connecting a circuit to the mechanism configured to dispense a consumable product contained in the storage unit after a remote command is received by the circuit.

The present invention further provides a dispenser system comprising: a housing including a front side; a mechanism, coupled to the front side of the housing, including a drive system and a storage unit; a circuit connected to the mechanism and configured to dispense a consumable product contained in the storage unit after a remote command is received by the circuit.

In one embodiment, the present invention can provide a pet treat dispenser that can be remotely controlled and operated.

In another embodiment, the present invention can provide a pet treat dispenser that can be remotely controlled and operated via the internet or wirelessly via a phone or other remote input device.

In another embodiment, the present invention can provide a pet treat dispenser that is relatively inexpensive to manufacture.

In another embodiment, the present invention can provide a pet treat dispenser that allows for auditory notifications to the pet when a treat is being dispensed.

In another embodiment, the present invention can provide a pet treat dispenser that is able to house and dispense a variety of different treats;

The present invention further includes other aspects in addition to or in place of those mentioned above. These aspects will become apparent to those skilled in the art from a reading of the following detailed description of the preferred embodiments when taken with reference to the accompanying drawings.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a front view of a dispenser system in a first embodiment of the present invention.

FIG. 2 is a side view of the dispenser system of FIG. 1.

FIG. 3 is a bottom view of the dispenser system of FIG. 1.

FIG. 4 is a top view of the dispenser system of FIG. 1.

FIG. 5 is an exploded view of the dispenser system of FIG. 1.

FIG. 6 is an isometric view of the dispenser systems of FIG. 1 in a loading stage of operation.

FIG. 7 is an isometric view of the dispenser systems of FIG. 1 in a ready stage of operation.

FIG. 8 is an isometric view of the dispenser systems of FIG. 1 in a dispense stage of operation.

FIG. 9 is an isometric view of the dispenser systems of FIG. 1 in a cleared stage of operation.

FIG. 10 is an isometric view of a dispenser system in a second embodiment of the present invention.

FIG. 11 is an isometric view of a dispenser system in a third embodiment of the present invention.

FIG. 12 is a flow chart of a method of operation of the container system in an embodiment of the present invention.

### DETAILED DESCRIPTION OF THE PREFERRED EMBODIMENTS

In the following description of the embodiments of the invention, reference is made to the accompanying drawings that form a part hereof, and in which are shown by way of illustration, exemplary embodiments in which the invention may be practiced. It is to be understood that other embodiments may be utilized and structural changes may be made without departing from the scope of the present invention.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention; however, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGS. Generally, the invention can be operated in any orientation.

In addition, where multiple embodiments are disclosed and described having some features in common, for clarity and ease of illustration, description, and comprehension thereof, similar and like features one to another will ordinarily be described with like reference numerals. The embodiments have been numbered first embodiment, second embodiment, etc. as a matter of descriptive convenience and are not intended to have any other significance or provide limitations for the present invention.

For expository purposes, the term “horizontal” as used herein is defined as a plane parallel to the plane or surface of the front side, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “processing” as used herein includes deposition of material, patterning, exposure, development, etching, cleaning, molding, and/or removal of the material or as required in forming a described structure. The term “system” as used herein means and refers to the method and to the apparatus of the present invention in accordance with the context in which the term is used (define system in a way that makes it useful for capturing front-end, back-end, or a combination).

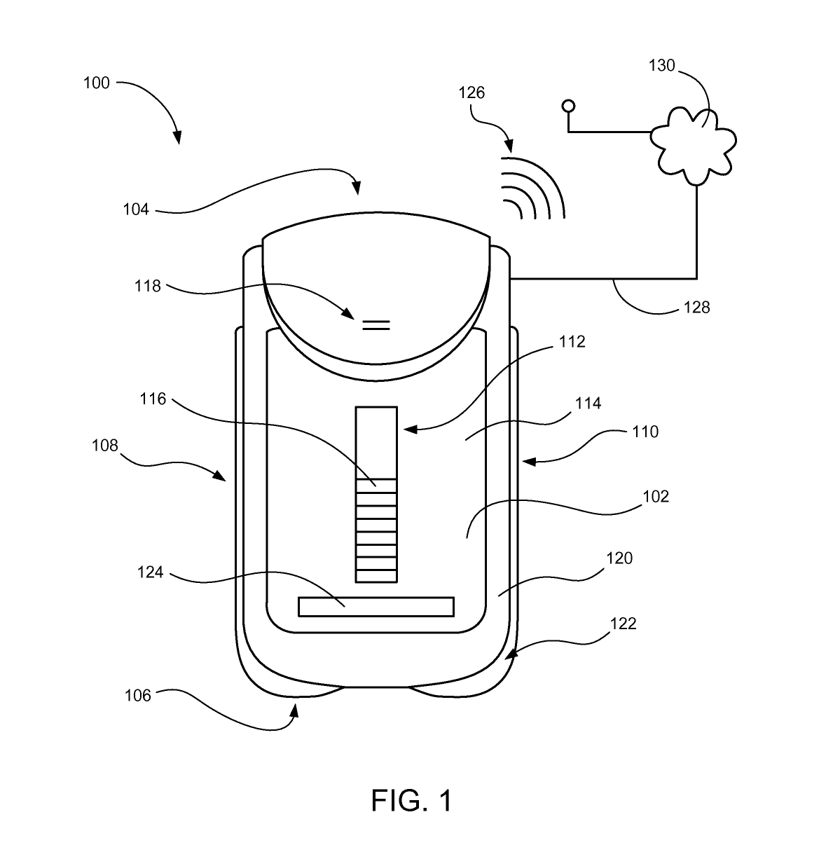

Referring now to FIG. 1, therein is shown a front view of a dispenser system 100 in a first embodiment of the present invention. The dispenser system 100 is shown having a front side 102, a top side 104, a bottom side 106, a left side 108, and a right side 110.

The dispenser system 100 is shown having a view port 112 centered within a front panel 114. The view port 112 within the front panel 114 can be any suitable size to allow a user to determine from an optical inspection how full the dispenser system 100 is and whether the dispenser system 100 needs to be refilled.

From the view port 112 a consumable product 116 can be seen filling over half of the view port 112. The consumable product 116 can include nutritious snacks. The consumable product 116 can be arranged to dispense a certain kind of the consumable product 116 in a specific order. The consumable product 116 can be produced with a shape that is required to be used with the dispenser system 100.

The front side 102 can also include a speaker 118 above the front panel 114 and aligned with the view port 112. The speaker 118 can alert a pet that the consumable product 116 is being or is about to be dispensed.

Around the front panel 114 a housing 120 can be structured to form portions of the front side 102, the top side 104, the bottom side 106, the left side 108, and the right side 110. The housing 120 can be formed from any suitable material such as injection molded plastic or a stamped metal.

The speaker 118 can include through holes or slits in the housing 120 along with the physical electromechanical speaker behind the housing 120. The housing 120 can surround the front panel 114 and provide a mounting platform and structural support for the front panel 114.

The housing 120 can include structural reinforcements 122 arranged to extend from the front side 102 to the top side 104, from the bottom side 106 around to the left side 108, and from the bottom side 106 around to the right side 110. The structural reinforcements 122 of the housing 120 can add significantly to the rigidity of the dispenser system 100 allowing for less material to be used during production or allowing for the dispenser system 100 to operate in a broader band of environmental conditions.

Below the view port 112 near the bottom of the front panel 114 is a dispenser tray 124. The dispenser tray 124 is configured to dispense the consumable product 116 individually when required. The dispenser system 100 can include a wireless connection 126 or a wired connection 128 that connects the dispenser system 100 to a network 130.

The network 130 can be a telephone network, the internet, a local network, or a private network. The wired connection 128 can be any suitable wired connection including metal wire connections like rs232, usb, and cat 5 or 6, or can be a fiber optic connection. The wireless connection 126 can utilize the WiFi 802.11 standards, Bluetooth, or even a mobile phone signal.

The dispenser system 100 allows pet owners to remotely provide the consumable product 116 to their pets via the wireless connection 126 or the wired connection 128 to the network 130. The pet owners can utilize an application native to their cell phones, a website, text, or even a remote control to signal the dispenser system 100 to load the dispenser tray 124 and dispense the consumable product 116.

The dispenser system 100 enables pet owners to remotely care for the needs of their pets with human concern and judgment rather than simply relying on a timer. The dispenser system 100 can be powered by a standard wall outlet with a battery backup, with batteries alone, or even a wireless power source.

The dispenser system 100 is contemplated to be used in the pet care industry. However, it is to be clearly noted that the present invention may be applied to other industries as well where a remotely controlled/operated dispensing device is desirable. In one application in the pet care industry, each dispenser system 100 would be manufactured in a way that is relatively inexpensive and user friendly to operate.

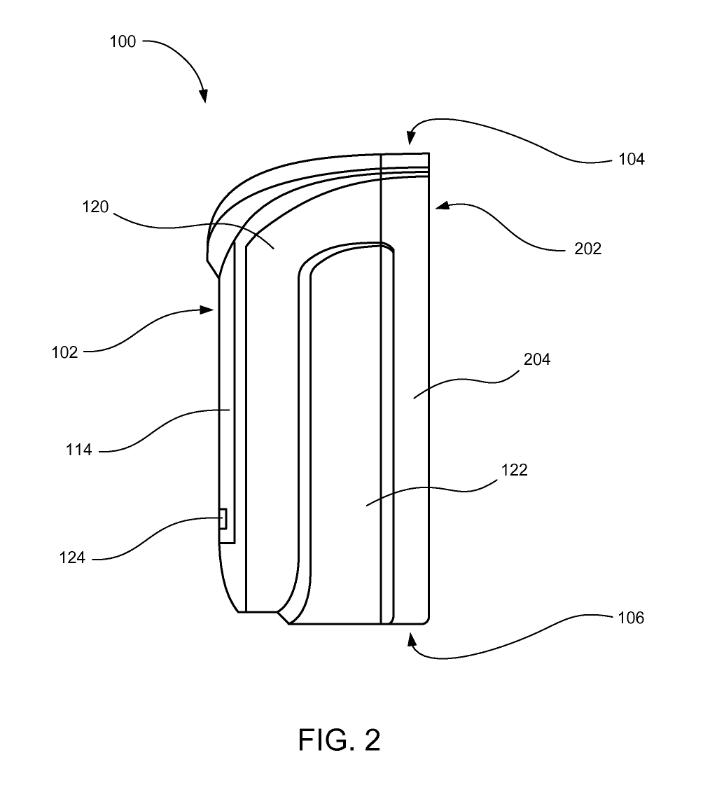

Referring now to FIG. 2, therein is shown a side view of the dispenser system 100 of FIG. 1. The dispenser system 100 is depicted showing the front panel 114 on a portion of the front side 102 with the dispenser tray 124 positioned within the front panel 114 and along a bottom part of the front panel 114.

The housing 120 can be seen surrounding the front panel 114 and extending from the front side 102 back toward a back side 202. As the housing 120 extends from the front side 102 toward the back side 202, the housing 120 contacts a back plate 204.

The back plate 204 can extend from the back side 202 toward the front side 102 and from the bottom side 106 to the top side 104. The structural reinforcements 122 can be formed in both the housing 120 and the back plate 204.

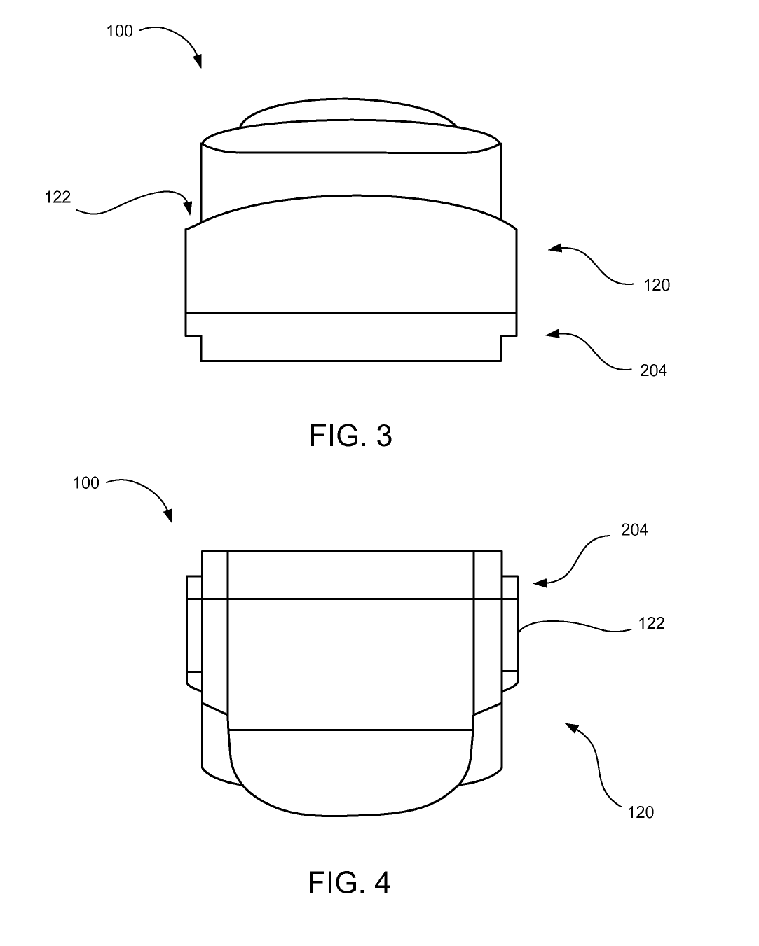

Referring now to FIG. 3, therein is shown a bottom view of the dispenser system 100 of FIG. 1. The dispenser system 100 is depicted having the housing 120 contacting the back plate 204. The structural reinforcements 122 are shown formed partially within the housing 120 and partially within the back plate 204.

Forming the structural reinforcements 122 within the housing 120 and the back plate 204 has been discovered to improve the structural rigidity of the dispenser system 100. The structural reinforcements 122 also provide the additional functionality of providing a compact form factor while housing important components.

Referring now to FIG. 4, therein is shown a top view of the dispenser system 100 of FIG. 1. The dispenser system 100 is depicted having the housing 120 contacting the back plate 204. The structural reinforcements 122 are shown formed partially within the housing 120 and partially within the back plate 204.

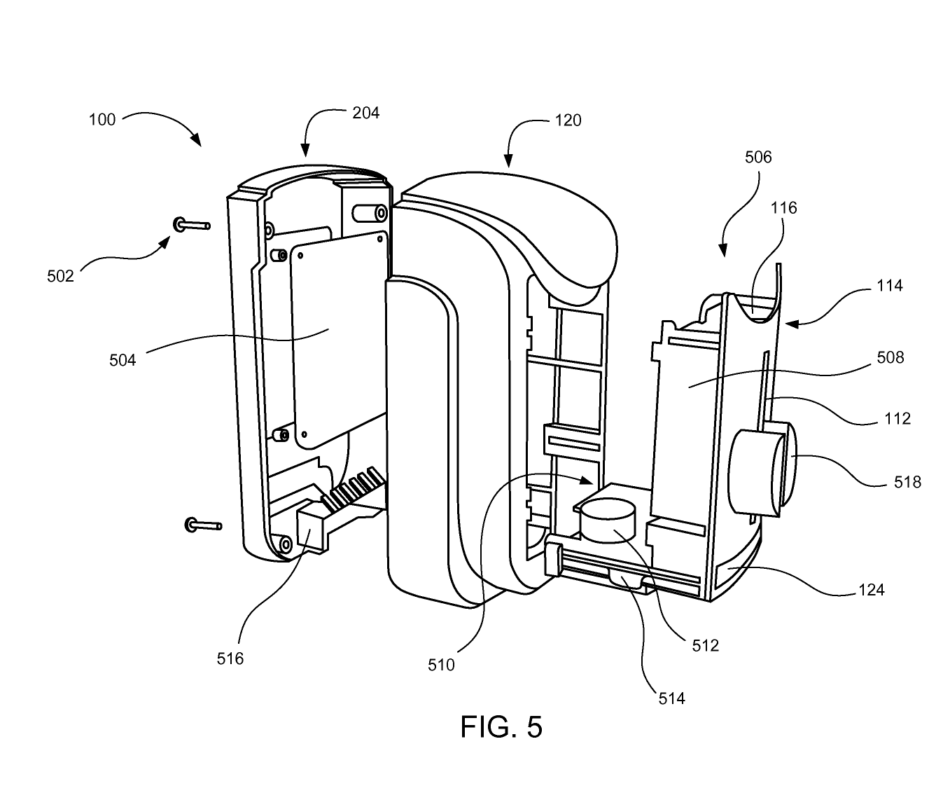

Referring now to FIG. 5, therein is shown an exploded view of the dispenser system 100 of FIG. 1. The dispenser system 100 is depicted having the back plate 204 aligned with the housing 120 aligned with the front panel 114.

Fasteners 502 are shown to align and connect the housing 120 with the back plate 204. The fasteners 502 can be any suitable fastener and can include threaded or unthreaded mechanical fasteners, chemical fasteners (such as glue or epoxy), and can even include non-mechanical non-chemical magnetic fasteners.

Within the back plate 204 a circuit such as a circuit board 504 is shown mounted off center within the back plate 204. The circuit board 504 can include many components required to drive, operate, communicate, signal, control, and regulate the dispenser system 100. As an example the circuit board 504 can include a micro-controller or micro-processor, driver amplifiers, wireless or wired communication modules, DC stepper control modules, audio amplifiers, and timers. Those of ordinary skill in the art will recognize that other components can be included and are inherently required to allow the dispenser system 100 to function as described herein.

The circuit board 504 can also facilitate connection and communication with the network 130 of FIG. 1 via the wireless connection 126 of FIG. 1 or the wired connection 128 of FIG. 1. The circuit board 504 can include memory and instructions configured to perform the actions communicated from the network 130 by the pet owner.

The front panel 114 is shown as part of a larger mechanism 506. The mechanism 506 can include the front panel 114 along with the dispenser tray 124. Behind the front panel 114 the mechanism 506 also includes a storage unit 508 and a drive system 510.

The storage unit 508 can be seen to include the consumable product 116 which can be viewed from the view port 112. The storage unit 508 can be configured behind the front panel 114 and above the drive system 510. The drive system 510 can be configured below the storage unit 508 and behind the dispenser tray 124.

The dispenser tray 124 can be coupled to the drive system 510 and the storage unit 508. The dispenser tray 124 can be loaded with the consumable product 116 from the storage unit 508 and be driven in and out to dispense the consumable product 116 by the drive system 510.

The drive system 510 can include a motor 512 coupled to gearing 514. The motor 512 can be a DC stepper motor or other suitable motor configured to control the motion of the dispenser tray 124. The gearing 514 can be configured to provide smoother motion to the dispenser tray 124 or can be configured to provide mechanical advantage when moving the dispenser tray 124 with the motor 512 when lower power consumption is required.

The mechanism 506 can be communicatively coupled to the circuit board 504 through the housing 120. The circuit board 504 can control the mechanism 506 with a communication path established through a connector 516 that can be in direct physical contact with the mechanism 506 when the dispenser system 100 is collapsed.

The mechanism 506 is further depicted including a load lock 518 in front of the front panel 114 and above the dispenser tray 124. The load lock 518 can project outward when the storage unit 508 needs to be refilled with the consumable product 116. When the load lock 518 is extended the load lock 518 does not obscure the view port 112 to provide the added functionality of seeing the amount of consumable product 116 within the storage unit 508 when the storage unit 508 is being filled.

Referring now to FIG. 6, therein is shown an isometric view of the dispenser system 100s of FIG. 1 in a loading stage of operation. The dispenser system 100 is depicted having the consumable product 116 being loaded into the storage unit 508.

To facilitate the loading of the dispenser system 100 the mechanism 506 is extended out from the housing 120 to expose the storage unit 508 and provide clearance for the consumable product 116 to be loaded without contact with the housing 120.

The consumable product 116 can be shown in a shape of a dog bone that correlates to the shape of the storage unit 508. The consumable product 116 can be shaped in a way that is required for the mechanism 506 to properly move the consumable product 116 within the mechanism 506 and the storage unit 508.

The load lock 518 is shown extended. The load lock 518 provides a handle or a grip to manually open or close the mechanism 506. The load lock 518 can function as a primary method of moving the mechanism 506 in or out from the housing 120 during cleaning or loading, or it may be a backup method. It is contemplated that the mechanism 506 can be extended from the housing 120 with a remote command by the pet owner over the wireless connection 126 of FIG. 1 or wired connection 128 of FIG. 1.

It is also contemplated that the load lock 518 can be utilized to move the mechanism 506 if the mechanism 506 is stuck or does not respond to the remote command by the pet owner. In typical use, a pet owner would open the mechanism 506 and fill the storage unit 508 with consumable product 116 of his/her choosing and close the dispenser system 100.

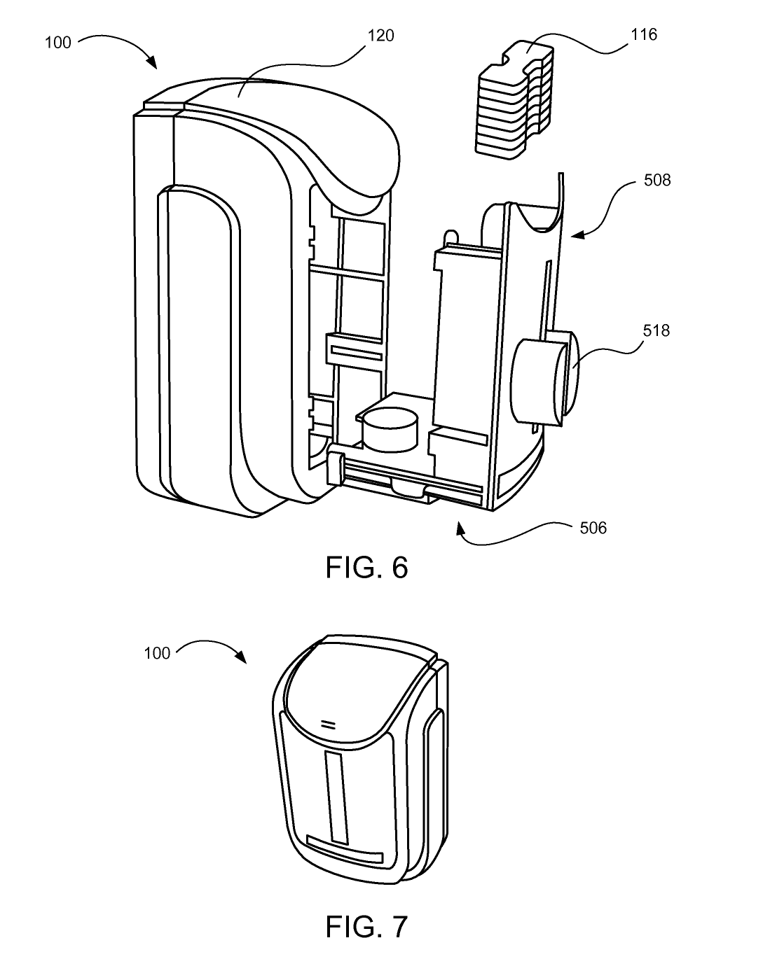

Referring now to FIG. 7, therein is shown an isometric view of the dispenser system 100s of FIG. 1 in a ready stage of operation. The dispenser system 100 can be placed in a low power standby mode to await an instruction from the pet owner. When the dispenser system 100 is in the standby mode the dispenser system 100 can monitor the wireless connection 126 of FIG. 1 or the wired connection 128 of FIG. 1 for an instruction.

The dispenser system 100 can further perform self-cleaning cycles or calibration cycles when awaiting a command to dispense the consumable product 116 of FIG. 1. It is further contemplated that the dispenser system 100 can report the level and freshness of the consumable product 116 to the pet owner over the wireless connection 126 or the wired connection 128 when awaiting a command or immediately after a command is received but before the dispense action is carried out.

Referring now to FIG. 8, therein is shown an isometric view of the dispenser system 100s of FIG. 1 in a dispense stage of operation. The dispenser system 100 is shown having the dispenser tray 124 in an extended position and containing the consumable product 116 for delivery to a pet.

As the dispenser tray 124 moves out the speaker 118 can create an auditory signal 802 to alert a pet that the consumable product 116 will be dispensed. The speaker 118 can be configured to generate the auditory signal 802 before, during, or after the consumable product 116 is dispensed.

The speaker 118 can be configured to generate the auditory signal 802 unique to the type of consumable product 116 being dispensed. It is further contemplated that the speaker 118 can generate the auditory signal 802 in a frequency range not perceptible to the human ear while simultaneously being perceptible to the pet. The auditory signal 802 may consist of any type of signal, including the pet owner's own voice which may provide a comfortable soothing feeling for the pet.

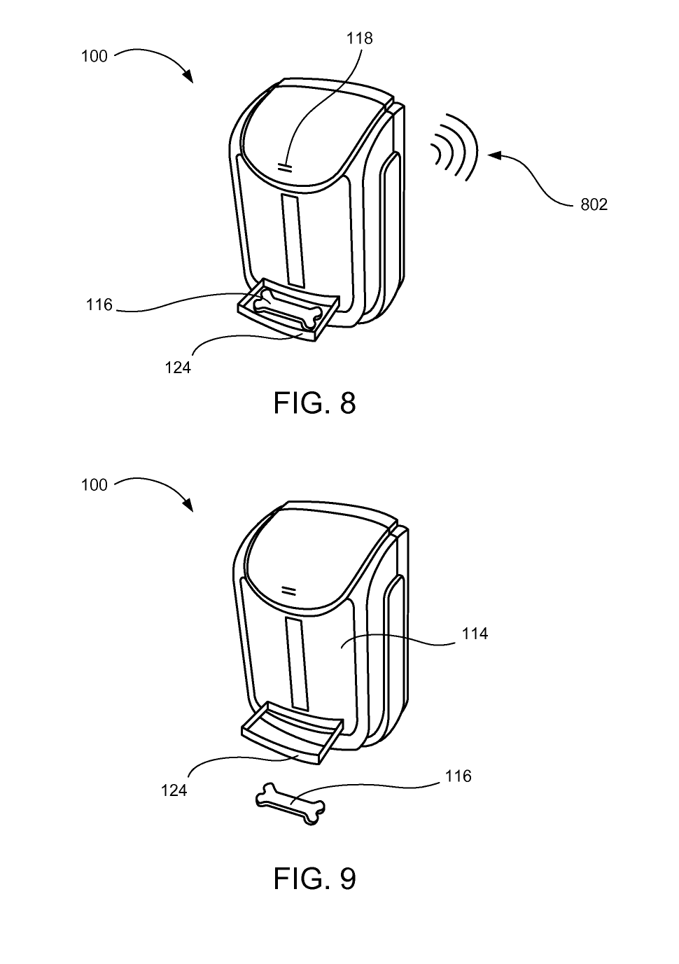

Referring now to FIG. 9, therein is shown an isometric view of the dispenser system 100s of FIG. 1 in a cleared stage of operation. The dispenser system 100 is depicted releasing the consumable product 116 from the dispenser tray 124.

When the dispenser system 100 receives a signal from the pet owner to open, the dispenser tray 124 will open, allowing the consumable product 116 to be dispensed, by either being pushed or dropped from the front panel 114. The pet would then eat the treat.

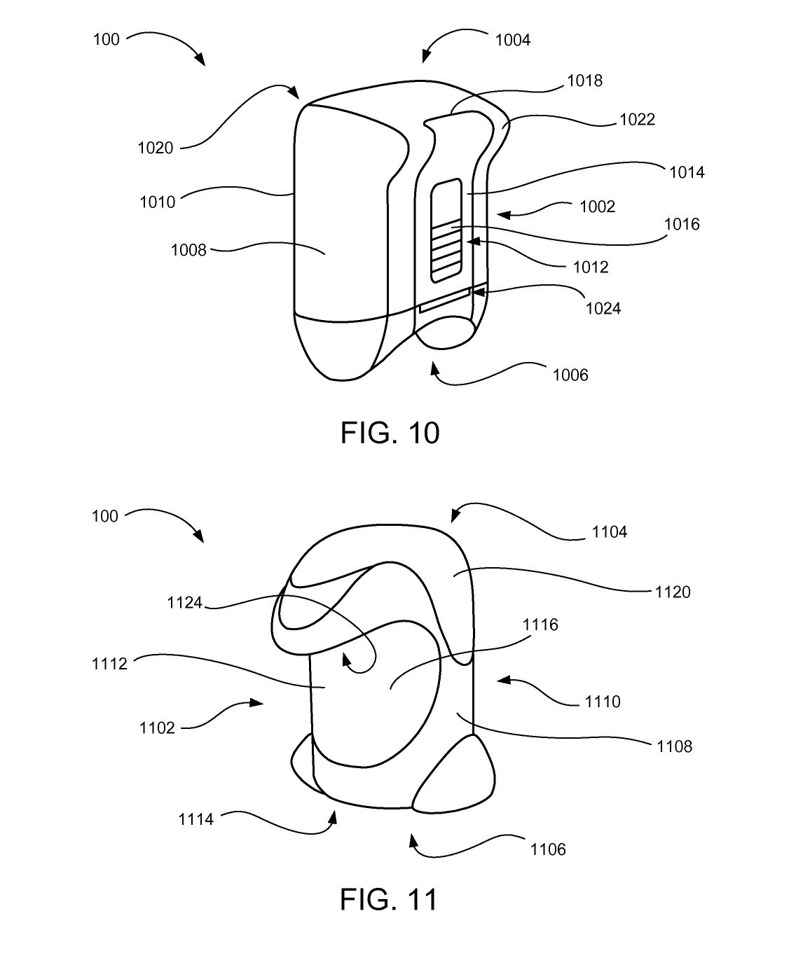

Referring now to FIG. 10, therein is shown an isometric view of a dispenser system 1000 in a second embodiment of the present invention. The dispenser system 1000 is shown having a front side 1002, a top side 1004, a bottom side 1006, a left side 1008, and a back side 1010.

The dispenser system 1000 is shown having a view port 1012 centered within a front panel 1014. The view port 1012 within the front panel 1014 can be any suitable size to allow a user to determine from an optical inspection how full the dispenser system 1000 is and whether the dispenser system 1000 needs to be refilled.

From the view port 1012 a consumable product 1016 can be seen filling the view port 1012. The consumable product 1016 can include nutritious snacks. The consumable product 1016 can be arranged to dispense a certain kind of the consumable product 1016 in a specific order. The consumable product 1016 can be produced with a shape that is required to be used with the dispenser system 1000. The front panel 1014 can slide or hinge open to refill the consumable product 1016.

The front side 1002 can also include a speaker 1018 above the front panel 1014 and aligned with the view port 1012. The speaker 1018 can alert a pet that the consumable product 1016 is being or is about to be dispensed.

Around the front panel 1014 a housing 1020 can be structured to form portions of the front side 1002, the top side 1004, the bottom side 1006, the left side 1008, and the back side 1010. The housing 1020 can be formed from any suitable material such as injection molded plastic or a stamped metal.

The speaker 1018 can include through holes or slits in the housing 1020 along with the physical electromechanical speaker behind the housing 1020. The housing 1020 can surround the front panel 1014 and provide a mounting platform and structural support for the front panel 1014. The structural reinforcements 1022 of the housing 1020 can add significantly to the rigidity of the dispenser system 1000 allowing for less material to be used during production or allowing for the dispenser system 1000 to operate in a broader band of environmental conditions.

Below the view port 1012 near the bottom of the front panel 1014 is a dispenser port 1024. The dispenser port 1024 is configured to dispense the consumable product 1016 individually when required.

The dispenser system 1000 allows pet owners to remotely provide the consumable product 1016 to their pets via a wireless connection or a wired connection to a network. The pet owners can utilize an application native to their cell phones, a website, text, or even a remote control to signal the dispenser system 1000 to eject the consumable product 1016.

The dispenser system 1000 enables pet owners to remotely care for the needs of their pets with human concern and judgment rather than simply relying on a timer. The dispenser system 1000 can be powered by a standard wall outlet with a battery backup, with batteries alone, or even a wireless power source.

The dispenser system 1000 is contemplated to be used in the pet care industry. However, it is to be clearly noted that the present invention may be applied to other industries as well where a remotely controlled/operated dispensing device is desirable. In one application in the pet care industry, each dispenser system 1000 would be manufactured in a way that is relatively inexpensive and user friendly to operate.

Referring now to FIG. 11, therein is shown an isometric view of a dispenser system 1100 in a third embodiment of the present invention. The dispenser system 1100 is shown having a front side 1102, a top side 1104, a bottom side 1106, a right side 1108, and a back side 1110.

The dispenser system 1100 is shown having a view port 1112 centered within a front panel 1114 and wrapping around the front side 1102 to the right side 1108. The view port 1112 within the front panel 1114 can be any suitable size to allow a user to determine from an optical inspection how full the dispenser system 1100 is and whether the dispenser system 1100 needs to be refilled.

From the view port 1112 a consumable product 1116 can be seen filling the view port 1112. The consumable product 1116 is depicted as a liquid nutrient solution. It is contemplated that the consumable product 1116 can be liquid, semi liquid or be a liquid with suspended solids therein. The consumable product 1116 can be contained in a refillable package that can be dropped into the dispenser system 1100 without being opened. The front panel 1114 can slide or hinge open to refill the consumable product 1116.

Around the front panel 1114 a housing 1120 can be structured to form portions of the front side 1102, the top side 1104, the bottom side 1106, the right side 1108, and the back side 1110. The housing 1120 can be formed from multiple components and multiple different types and colors of materials.

The housing 1120 can surround the front panel 1114 and provide a mounting platform and structural support for the front panel 1114. Structural reinforcements 1122 formed within the housing 1120 can add significantly to the rigidity of the dispenser system 1100 allowing for less material to be used during production or allowing for the dispenser system 1100 to operate in a broader band of environmental conditions.

Above the view port 1112 above the front panel 1114 is a dispenser port 1124. The dispenser port 1124 is configured to dispense the consumable product 1116 at controllable doses when required.

The dispenser system 1100 allows pet owners to remotely provide the consumable product 1116 to their pets via a wireless connection or a wired connection to a network. The pet owners can utilize an application native to their cell phones, a website, text, or even a remote control to signal the dispenser system 1100 to dispense the consumable product 1116.

The dispenser system 1100 enables pet owners to remotely care for the needs of their pets with human concern and judgment rather than simply relying on a timer. The dispenser system 1100 can be powered by a standard wall outlet with a battery backup, with batteries alone, or even a wireless power source.

The dispenser system 1100 is contemplated to be used in the pet care industry. However, it is to be clearly noted that the present invention may be applied to other industries as well where a remotely controlled/operated dispensing device is desirable. In one application in the pet care industry, each dispenser system 1100 would be manufactured in a way that is relatively inexpensive and user friendly to operate.

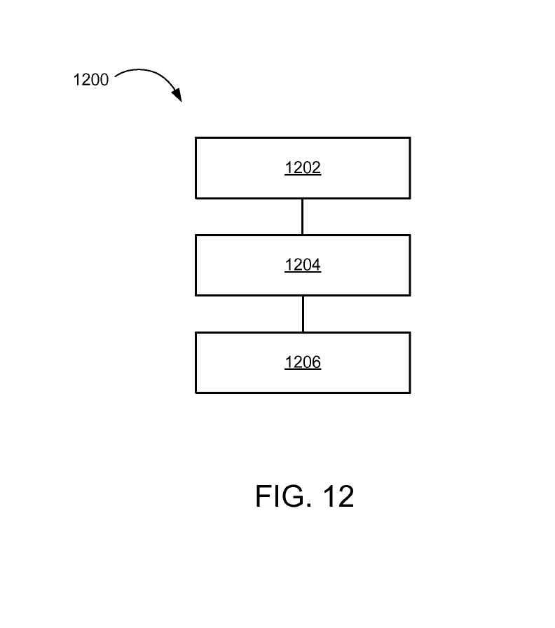

Referring now to FIG. 12, therein is shown a flow chart of method of manufacturing 1200 the dispenser system 100 in an embodiment of the present invention. The method of manufacturing 1200 the dispenser system 100 includes: providing a housing including a front side in a block 1202; coupling a mechanism to the front side of the housing, the mechanism including a drive system and a storage unit in a block 1204; and connecting a circuit to the mechanism configured to dispense a consumable product contained in the storage unit after a remote command is received by the circuit in a block 1206.

Thus, it has been discovered that the dispenser system, method, and apparatus of the present invention furnish important and heretofore unknown and unavailable solutions, capabilities, and functional aspects.

The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent to those skilled in the art in light of the current description.

Accordingly, it is intended to embrace all such alternatives, modifications, and variations, which fall within the scope of the included claims. All matters set forth herein or shown in the accompanying drawings are to be interpreted in an illustrative and non-limiting sense.

1. A method of manufacturing a dispenser system comprising:
providing a housing including a front side;
coupling a mechanism to the front side of the housing, the mechanism including a drive system, a dispenser tray configured to move out away from the front side with a consumable product therein and the dispenser tray further configured to drop the consumable product when in an extended position, and a storage unit; and
connecting a circuit to the mechanism configured to dispense the consumable product.

2. The method of claim 1 further comprising mounting a speaker to the housing configured to alert a pet before, during, or after, the consumable product is dispensed.

3. The method of claim 1 further comprising mounting a speaker to the housing configured to generate an auditory signal unique to the type of the consumable product being dispensed.

4. The method of claim 1 wherein connecting the circuit to the mechanism includes connecting the circuit to the mechanism configured to dispense the consumable product having a size or shape required for the mechanism to operate.

5. The method of claim 1 wherein connecting the circuit to the mechanism includes connecting the circuit to the mechanism configured to dispense the consumable product as a liquid, a solid, or a combination thereof.

6. A method of manufacturing a dispenser system comprising:
providing a housing including a structural reinforcement on a front side;
coupling a mechanism including a drive system, a dispenser tray configured to move out away from the front side with a consumable product therein and the dispenser tray further configured to drop the consumable product when in an extended position, a storage unit and a front panel to the front side of the housing; and
connecting a circuit to the mechanism configured to dispense the consumable product.

7. The method of claim 6 wherein coupling the mechanism having the front panel includes coupling the mechanism having the front panel including a view port therein configured to show inside the storage unit.

8. The method of claim 6 wherein connecting the circuit includes connecting the circuit configured to receive a remote command from a wireless connection, a wired connection, or a combination thereof.

9. The method of claim 6 wherein coupling the mechanism includes coupling the mechanism having a load lock for manually moving the storage unit.

10. The method of claim 6 wherein coupling the mechanism including the drive system includes coupling the mechanism including the drive system having a motor coupled to a gear.

11. A dispenser system comprising:
a housing including a front side;
a mechanism, coupled to the front side of the housing, including a drive system, a dispenser tray configured to move out away from the front side with a consumable product therein and the dispenser tray further configured to drop the consumable product when in an extended position, and a storage unit; and
a circuit connected to the mechanism and configured to dispense the consumable product.

12. The system of claim 11 further comprising a speaker mounted to the housing configured to alert a pet before, during, or after, the consumable product is dispensed.

13. The system of claim 11 further comprising a speaker mounted to the housing configured to generate an auditory signal unique to the type of the consumable product being dispensed.

14. The system of claim 11 wherein the circuit is configured to dispense the consumable product having a size or shape required for the mechanism to operate.

15. The system of claim 11 wherein the circuit is configured to dispense the consumable product as a liquid, a solid, or a combination thereof.

16. The system of claim 11 wherein:
the housing further includes a structural reinforcement on the front side;
the mechanism includes a front panel.

17. The system of claim 16 wherein the front panel has a view port therein configured to show inside the storage unit.

18. The system of claim 16 wherein the circuit is configured to receive a remote command from a wireless connection, a wired connection, or a combination thereof.

19. The system of claim 16 wherein the mechanism includes a load lock for manually moving the storage unit.

20. The system of claim 16 wherein the drive system further includes a motor coupled to a gear.
